(19) United States
(12) Patent Application Publication
(10) Pub. No.: US 2006/0289457 A1
(43) Pub. Date: Dec. 28, 2006

(54) Heating device comprising an adjustable heater plub/flame monitor

(75) Inventors: Christian Baecker, Fuerstenfeldbruck (DE); Felix Wolf, Langenau (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 10/549,189

(22) PCT Filed: Mar. 17, 2004
(86) PCT No.: PCT/DE04/00539

§ 371 Date: Aug. 8, 2006

(30) Foreign Application Priority Data
Mar. 18, 2003 (DE) 103118985

(51) Int. Cl. H05B 1/02

(52) U.S. Cl. 219/497

(57) ABSTRACT

A heater for a vehicle is provided with a glow plug/flame detector and a control device for controlling the electrical wattage supplied to the glow plug during the starting phase of the heater. In order to devise a vehicle which offers a high safety standard and reduced emission of pollutants during a starting process of its heater, the glow plug/flame detector can be adjusted to a certain resistance value (10), and during control, the electric wattage supplied to the glow plug/flame detector can be determined, and the determined actual wattage value (20) can be compared to at least one threshold wattage value (30), and the starting phase can be influenced depending on this.

### BACKGROUND OF THE INVENTION

1. Field of the Invention

The invention relates to a heater for a vehicle with a glow plug/flame detector and a control device for controlling the electrical wattage supplied to the glow plug during the starting phase of the heater. Furthermore, the invention relates to a vehicle with such a heater and a process for operating such a heater.

2. Description of Related Art

Heaters of the aforementioned type are used, for example, in ground vehicles, ships or aircraft, in order to heat a passenger compartment or to preheat the cooling water of an internal combustion engine in a cold start. In the aforementioned heaters, devices which are based on measuring the resistance of a glow plug/flame detector are used for detection of a flame-out.

It is common to heaters that there is a burner which is operated with fuel. During operation of the burner a flame burns in it. If the flame goes out unexpectedly, it is desirable in any case that this is quickly detected and the supply of fuel is interrupted under certain circumstances. In this way, additional emission of pollutants will be avoided and reliable operation of the burner will be ensured.

In processes for detecting the extinction of a flame, i.e., flame-out, according to the prior art, a flame detector is used with an electrical resistance which is measured. The electrical resistance depends on the temperature, so that a flame-out can be deduced from a drop of the resistance.

Especially components which act as electrical igniters or glow plugs when the burner is started are used as flame detectors. These components are also called a glow plug/flame detector in this application.

To detect a flame-out, processes are known in which a defined resistance threshold is assumed. The resistance threshold follows from the characteristic of the resistance value of the glow plug/flame detector in a flame-on situation. Moreover, processes for flame detection are known in which the gradient of the change of the resistance value is evaluated.

German Patent DE 198 22 140 C1 discloses a process for flame monitoring in a motor vehicle heater in which the resistance value of a glow plug is evaluated by a control device in the incandescent pauses in which there is no supply voltage on the glow plug, for detection of the flame in a combustion chamber. Monitoring takes place by testing whether the spiral-wound filaments of the glow plug assume a predetermined resistance value within a given time interval.

German Patent Application DE 199 03 305 A1 discloses a process for monitoring the flame in a motor vehicle heater which is provided with a temperature sensor or flame detector which projects into the combustion chamber. The measurement signal of the flame detector is supplied to a control device and is evaluated for flame detection as a function of given temperature threshold values and in addition of the temperature gradients. With this process, flame-off detection is possible after the starting element in the form of a flame detector or glow plug has been completely turned off.

German Patent DE 199 36 729 C1 discloses a process for triggering a glow plug for igniting a motor vehicle heater in which the glow plug is triggered at least during the final phase of a preheating phase with a constant wattage which produces a radiation temperature of the glow plug which is typical of the vehicle heater. Then, the glow plug resistance is measured at the end of the preheating phase and the wattage applied to the glow plug is controlled by cycling to a constant resistance in an ignition phase which follows the preheating phase.

German Patent DE 100 25 953 A1 discloses a process for triggering a glow plug for igniting a vehicle heater in which, at the start of the preheating phase, the glow plug is operated with a constant voltage which is used to bring the glow plug quickly into the vicinity of the ignition temperature until a given percentage of the value of the resistance of the glow plug which has been determined to be optimum in a preceding preheating starting phase is reached.

In the known heaters, especially the detection of a flame-off situation during the actual starting phase of the heater is currently difficult. At present the absence of a flame can only be detected at that instant at which combustion operation would have had to be reached under full load.

### SUMMARY OF THE INVENTION

The object of the invention is to devise a vehicle which offers a high safety standard and reduced emission of pollutants during a starting process of its heater, and in which, especially, the presence of the flame during the starting phase of the heater can be continuously checked.

The invention is achieved with a heater of the initially mentioned type in which the control device can adjust the glow plug/flame detector to a certain resistance value, and during control, the electric wattage supplied to the glow plug/flame detector can be determined, and the determined actual wattage value can be compared to at least one threshold wattage value and the starting phase can be influenced depending on this.

The object is furthermore achieved with a vehicle which is equipped with such a heater, and with a process for operating a heater with the following steps: adjustment of the glow plug/flame detector to a certain resistance value, determination of the electrical wattage supplied to the glow plug/flame detector during control; comparison of the determined actual wattage value to at least one threshold wattage value; and influencing the starting phase as a function of the comparison.

In the heater in accordance with the invention, before the actual starting phase, the glow plug/flame detector is adjusted to a certain resistance value, resulting in that a certain amount of energy is supplied to the glow plug/flame detector, and therefore, it assumes a given temperature. This temperature and the thermal energy stored in the glow plug/flame detector should be sufficient to ignite the fuel which is routed to the glow plug/flame detector on the latter. With ignition, the flame forms, the continuation of which is the prerequisite for problem-free and low-polluting operation of the heater.

The basis of the invention is the finding that the supplied electrical wattage or the trigger wattage of the glow plug/flame detector which is necessary for obtaining the predetermined temperature, and thus, for obtaining the adjusted resistance value of the glow plug/flame detector then, for example, does not exceed a certain value or threshold value if a flame is continuously present. Conversely, if a disruption or unwanted change of the flame occurs, this can be detected based on a correctly preselected threshold value of the supplied wattage being exceeded or not being reached.

The detection of a change of the flame, i.e., especially, the formation or extinction of the flame, takes place in accordance with the invention during the actual starting phase, therefore, during that phase in which the glow plug/flame detector is heated up so that it ignites the supplied fuel. In other words, according to the invention, for example, for each instant of the starting phase, a salient condition is produced which makes it possible, depending on the electrical wattage required for obtaining the resistance value, to detect the current starting state and thus to influence the starting attempt.

Based on the approach of the invention, a signal for premature break-off of the starting phase can be generated when the comparison indicates that the threshold wattage value has been exceeded. Therefore, in accordance with the invention, for example, a new start is begun when, as a result of a flame-out, the glow plug/flame detector is not additionally heated by the flame during heating and ignition. In this case, the heat input of the flame is lacking and the glow plug/flame detector receives a higher electrical wattage because it is adjusted to the same resistance value and thus to the same temperature.

Alternatively or in addition, a signal for premature transition into combustion operation can be advantageously produced when the comparison indicates that the threshold wattage value has not be reached. In this way, the starting phase of a heater can be shortened when, for example, based on the optimum ambient conditions, the flame on the glow plug/flame detector has formed in an especially short time (so-called “good start”).

Furthermore, it is advantageous if a change of the starting sequence can be generated with the control device when the threshold wattage value is not reached. Here, individual states or phases can be skipped especially advantageously within the starting sequence.

Moreover, the starting phase can be advantageously subdivided into individual time intervals, different threshold wattage values being assigned to the individual time intervals. With such a differentiated view of the starting phase, for delayed flame formation (so-called “poor” or “late” start), the heater can be allotted sufficient time for complete flame formation. In this way, it is possible to prevent a flame which forms late from being smothered in the nucleus; this can occur, for example, in control solely based on time windows.

Furthermore, the control device of the invention can advantageously distinguish between different starting sequences and different threshold wattage values are advantageously assigned to the different starting sequences which are dependent on the ambient temperature. In this way, a major portion of the ambient conditions acting on a heater can be considered when the heater starts.

One embodiment of a process in accordance with the invention for controlling a heater is explained in detail below with reference to the accompanying drawings.

### BRIEF DESCRIPTION OF THE DRAWINGS

FIG. 1 is a diagram showing a first possibility of behaviors of the resistance value and of the wattage value of a glow plug/flame detector for a heater in accordance with the invention and

FIG. 2 is a diagram showing a second possibility of behaviors of the resistance value and of the wattage value of a glow plug/flame detector for a heater in accordance with the invention.

### DETAILED DESCRIPTION OF THE EMBODIMENT

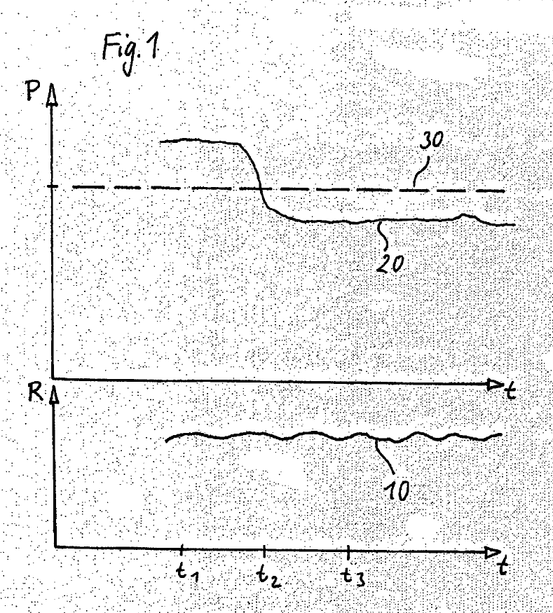

In FIG. 1, a first vertical axis R represents the resistance value on the glow plug/flame detector of a heater and a second vertical axis P the wattage value of the glow plug/flame detector while the horizontal axis t indicates time.

The behavior of the resistance value of a glow plug/flame detector on the burner of a heater during the starting phase, i.e., during heat-up and holding of the glow plug/flame detector at the ignition temperature, is shown in FIG. 1 with the curve 10.

The resistance value is adjusted to a certain, essentially constant theoretical resistance value according to line 10 during the starting phase. The line 10 is slightly undulating; indicating that the resistance value fluctuates at least slightly over time. The fluctuations are dictated by the control process in which the control device of the heater determines the actual resistance value and compares it to the theoretical resistance value. The actual resistance value is corrected subsequently with a certain delay.

During control, the glow plug/flame detector receives electrical wattage which is illustrated in the upper section of FIG. 1 by means of the curve 20. At the time t₁, the wattage received per unit of time is comparatively high. At this instant t₁, the glow plug/flame detector is heated up, no fuel yet having been supplied and ignited.

At time t₂, fuel is finally made available and it is ignited, by which a flame is formed in the burner. In the area of the glow plug/flame detector, thermal energy which is transferred to the latter is formed by the flame.

As explained above, the control of the glow plug/flame detector is tuned such that its resistance value is essentially constant. At this point, since thermal energy is provided by the flame, less electrical energy is necessary to keep the glow plug/flame detector at the same temperature, and thus, at the same resistance value. The actual wattage value of the glow plug/flame detector therefore drops according to line 20 at the time t2.

The actual power consumption is compared to a threshold value which is shown in FIG. 1 as a horizontal line 30. If the actual power consumption at time t2 drops below a threshold value, this indicates that the flame has been properly formed. For a flame which burns constantly, the power consumption of the glow plug/flame detector remains at a low level; this is illustrated especially at time t3.

The glow plug/flame detector receives electrical energy until it is turned off or turned down. It is advantageously turned off when a flame has burned constantly beyond a certain time interval.

The threshold value as shown by line 30 allows simple, and moreover, exact determination of whether the desired flame is formed and is burning constantly. Additionally, a differentiated conclusion about the quality of the flame can be drawn by stipulating different threshold values, especially staggered threshold values, for certain time intervals within the starting phase.

Furthermore, a tolerance band for the actual power consumption can be advantageously defined; adherence to it allows a proper ignition process to be deduced. The tolerance band is, for example, limited on its lower edge by threshold values which are variously high beyond the time axis. Threshold values not being reached indicate that the actual power consumption of the glow plug/flame detector does not correspond to the desired value and therefore there must be a problem. In the same way, on the top edge of the tolerance band a threshold can be defined which indicates a properly ignited and burning flame.

The threshold values can also be made variable, and for example, can be fixed separately for each starting process depending on other parameters and can be taken by the control device from a memory table. Important parameters are, for example, the ambient temperature and the temperature of a component of the heater, especially of the burner. Furthermore, it can be advantageous if it is considered whether it is the initial start or a restart after a faulty start of the heater.

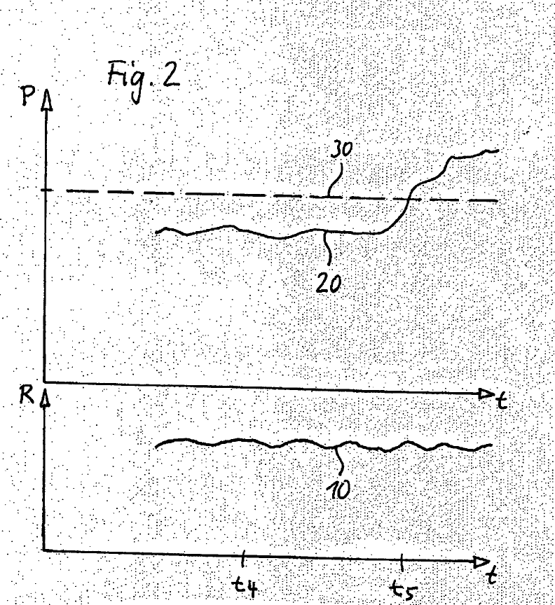

FIG. 2 shows a diagram which corresponds essentially to FIG. 1, in the lower part of FIG. 2, in turn, the almost constant resistance value R and in the upper part the pertinent behavior of the actual wattage value P being shown.

FIG. 2 shows the behavior of the power consumption P at a time t₄ at which a flame is burning properly on the glow plug/flame detector. The wattage value in this situation is less than the threshold value.

At a time t₅, for example, due to a large gas bubble in the fuel supply of the heater, a flame-out occurs. With the extinction of the flame, the delivery of thermal energy to the glow plug/flame detector also ends.

However, since the resistance of the glow plug/flame detector is adjusted to an almost constant value, the glow plug/flame detector based, on the control process, subsequently, receives higher electrical wattage; this is shown in FIG. 2 by the rise of the line 20 beyond the threshold 30. Exceeding of the threshold value is determined and the flame-out is detected in this way.

What is claimed is:

1-13. (canceled)

14. Method of operating a heater for a vehicle with a glow plug/flame detector and a control device for controlling the electrical wattage supplied to the glow plug during the starting phase of the heater, comprising the steps of:
using the control device to control the glow plug/flame detector to a certain resistance value,
during said control, determining the electric wattage supplied to the glow plug/flame detector, and
comparing the determined actual wattage value to at least one threshold wattage value and influencing the starting phase depending on the result of the comparison.

15. Method as claimed in claim 14, comprising the further step of generating a signal for premature break-off of the starting phase with the control device when the threshold wattage value has been exceeded.

16. Method as claimed in claim 14, comprising the further step of generating a change of the starting sequence with the control device when the threshold wattage value has been exceeded.

17. Method as claimed in claim 14, comprising the further step of generating a signal for premature transition into combustion operation with the control device when the threshold wattage value has not been reached.

18. Method as claimed in claim 14, wherein the starting phase is subdivided into individual time intervals, different threshold wattage values being assigned to the individual time intervals.

19. Method as claimed in claim 14, comprising the further step of using the control device to distinguish between different starting sequences depending on the ambient temperature and different threshold wattage values assigned to the different starting sequences which are dependent on the ambient temperature.
